(19) United States
(12) Patent Application Publication
(10) Pub. No.: US 2003/0225625 A1
(43) Pub. Date: Dec. 4, 2003

(54) Returns management systems and methods therefor

(76) Inventors: Michael Chew, San Jose, CA (US); Roland Oberdorfer, Mountain View, CA (US); Andrew A. Meyer, San Jose, CA (US); Vernon Wyatt, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/159,807

(22) Filed: May 31, 2002

(51) Int. Cl. G06F 17/60

(52) U.S. Cl. 705/24

(57) ABSTRACT

A computer-implemented method for handling a merchandise return request from a customer of a merchant. The method includes receiving customer identification data, the customer identification data being capable of uniquely identifying the customer among customers of the merchant. The method further includes receiving a return transaction definition, the return transaction definition includes at least one of a problem type parameter and a return transaction type parameter. The method additionally includes automatically ascertaining, from a database of items previously ordered, a set of return-eligible items. Each return-eligible item in the set of return-eligible items represents an item of merchandise previously ordered by the customer that conforms to the return transaction definition and predefined return-related business rules of the merchant.

### BACKGROUND OF THE INVENTION

The present invention relates to computer-implemented systems and methods for managing merchandise returns.

Order management software applications have long been employed by merchants to handle and execute orders placed by their customers. In the electronic commerce scenario, for example, a customer may place an order from a remote location, such as from his home or office, for one or more items of merchandise offered by a given merchant. The order may be placed, for example, via a telephone, via facsimile, or via a computer network such as the Internet. If a human operator is involved in taking the order, the customer may transmit the information about the item(s) to be purchased, the shipping and payment data, and the like to the human operator, who may then employ a order management system to track and execute the order.

During the ordering process, the order management application may create an invoice to keep track of the identity of the customer, the item(s) ordered, the amount and type of payment received, the shipping address, and the like. The various pieces of information pertaining to customers' orders may then be stored in a sales database to allow the merchant to, for example, track the status of the pending sales orders, fulfill the pending orders in a timely manner, and/or obtain information over time about the buying habit of a group of customers in general or a specific customer in particular so that the merchant can offer a product mix that maximizes customer satisfaction, sales and profits.

As is expected, a given percentage of the items sold may be subject to returns. Customers return merchandise for a variety of reasons, including for example buyer's remorse, damage during shipment, inferior or defective material or manufacture, unfulfilled expectation, and the like. When a customer desires to return merchandise, there is often an accompanying request for a refund, for exchanging the item to be returned with another item, which may have the same price or may have a different price. While merchandise returns are viewed by many merchants as an unpleasant but necessary part of business, returns are however an important part of a customer's shopping experience with that merchant. Thus, enlightened merchants who develop a good reputation for handling returns fairly and efficiently tend to find that they can more easily retain existing customers for repeat orders and/or attract new customers.

In the prior art, much effort has been devoted to improving order management applications that streamline the process of taking an order, receiving payment therefor, and fulfilling the order. This is perhaps not surprising since sales tends to be viewed as the front-end revenue-generating activity in many companies. However, there has not been an equal emphasis on streamlining the handling of merchandise returns. This is particularly true in the call center environment, which tends to be the route through which many customers contact their merchants for returns.

By way of example, many businesses employ human operators in call centers to interact with customers who wish to return or exchange a previously bought item Unlike the situation with the ordering process, it has been found that the returns process tends to involve more human interaction, perhaps because customers find comfort in being able to express dissatisfaction to and to receive personal attention from a human operator during a returns transaction. The information furnished by the customer regarding the item(s) to be returned and/or exchanged is entered by the call center operator into a returns database to generate a returns invoice. The returns software employed to receive and store information about returned merchandise may be as simple as a computerized form program or a spreadsheet. The generated returns invoice is then reconciled at a later time against the information from the ordering system and the information from the accounting system to facilitate receiving of the returned merchandise and/or the shipment of the replacement merchandise, as well as to facilitate settlement of any applicable charges or credits.

If the reconciliation is performed manually, there is a significant amount of labor and time delay associated with the returns process, which negatively impacts profitability and customer satisfaction. More typically, the reconciliation between the returns software and the sales database is typically performed using software. If the reconciliation is performed using software, the reconciliation software is typically custom-built and hard-coded to accommodate the return policy of a particular merchant as well as to bridge between the returns data and the specific data format of a given order management application.

Unfortunately, when the merchant's return policy changes, the reconciliation software must oftentimes be rewritten to reflect the changed policy. Likewise, if the merchant updates the order management application, the reconciliation software often requires recoding to work with the newly upgraded order management application. As can be appreciated by those skilled in the art, the amount of effort involved in writing, debugging, and testing software code, as well as in integrating the software code to work with different applications, is nontrivial.

Further, since the returns software and the order management software are not integrated, there exists an information and time gap, which makes it difficult for merchants and their customers to obtain accurate information at any given time about a particular returns transaction. Additionally, some customers may exploit the information and time gap to fraudulently make multiple demands for returns against a single purchased item. By the time the multiple returns invoices are reconciled against the original order in the order management software and the fraud is uncovered, the customer may have successfully obtained multiple “exchange” items and/or multiple returns credits against a single purchased item. Even if no fraud is intended, customers and customer service agents sometimes make mistakes, which may also result in multiple exchanged items and/or credits granted against a single purchased item

### SUMMARY OF THE INVENTION

The invention relates, in one embodiment, to a computer-implemented method for handling a merchandise return request from a customer of a merchant. The method includes receiving customer identification data, the customer identification data being capable of uniquely identifying the customer among customers of the merchant. The method further includes receiving a return transaction definition, the return transaction definition includes at least one of a problem type parameter and a return transaction type parameter. The method additionally includes automatically ascertaining, from a database of items previously ordered, a set of return-eligible items. Each return-eligible item in the set of return-eligible items represents an item of merchandise previously ordered by the customer that conforms to the return transaction definition and predefined return-related business rules of the merchant.

In another embodiment, the present invention relates to a computer-implemented returns management system for handling merchandise return requests from customers of a merchant. The computer-implemented returns management system includes a plurality of tables implemented in a relational database and a user-interface module configured to interact with one of a customer of the merchant and a customer service agent of the merchant. The user-interface module is configured to receive customer identification data and a return transaction definition associated with a request for merchandise return from a customer associated with the customer identification data. The computer-implemented returns management system additionally includes a business logic module communicably coupled with the user interface module and the plurality of tables. The business logic module includes computer instructions for ascertaining whether an item of merchandise previously purchased by the customer is eligible for return based on the return transaction definition and predefined return-related business rules of the merchant.

In yet another embodiment, the invention relates to a computer-implemented returns management system for handling merchandise return requests from customers of a merchant. The computer-implemented returns management system includes means for storing items previously ordered by customers of the merchant and predefined return-related business rules of the merchant. The computer-implemented returns management system further includes means for receiving customer identification data and a return transaction definition associated with a request for merchandise return from a customer associated with the customer identification data The computer-implemented returns management system additionally includes means, communicably coupled with the means for storing and means for receiving, for ascertaining based on the return transaction definition and the predefined return-related business rules of the merchant whether an item of merchandise previously purchased by the customer is eligible for return.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in accordance with one embodiment of the present invention, an exemplary flow chart describing the various steps associated with the front-end portion of a typical agent-assisted return for credit process.

FIG. 2 shows, in accordance with one embodiment of the present invention, the menu page of an order management system having an integrated return management capability.

FIG. 3 illustrates, in accordance with one embodiment of the present invention, a screen for displaying the customer's past order transactions.

FIG. 4 is an exemplary screen for inputting a return transaction definition in accordance with one embodiment of the present invention.

FIG. 5 is an exemplary screen for selecting the return-eligible items in accordance with one embodiment of the present invention.

FIGS. 6A and 6B illustrate, in accordance with embodiments of the present invention, exemplary follow-up screens for handling a return for credit transaction

FIGS. 6A and 6B illustrate, in accordance with embodiments of the present invention, exemplary follow-up screens for a return transaction in which there is an exchange for an item of equal value.

FIGS. 8A, 8B, 8C, and 8D illustrate, in accordance with embodiments of the present invention, exemplary follow-up screens for a return transaction in which there is an exchange for an item having a different value.

FIG. 9 illustrates, in accordance with one embodiment of the present invention, a diagram showing the various components of the integrated merchandise return system (IMRS).

FIG. 10 shows, in accordance with one embodiment of the present invention, the exemplary business logic functions as well as database tables involved in the agent-assisted return transaction of FIG. 1.

FIG. 11 shows, in one embodiment, an exemplary flow for backend processing.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The invention relates, in one embodiment, to a computer-implemented method and system for efficiently handling merchandise return requests made by customers of a merchant. Generally speaking, a merchandise return request may include a request to return an ordered item for credit, a request to exchange an ordered item for another item having a similar value (including the identical item again), or a request to exchange the ordered item for another item having a different value (in which case, a credit or debit may be due). As the term is employed herein, a customer may include a consumer, a business that purchases goods from another business for its own use, for resale and/or distribution, an alliance channel partner that receives goods from another alliance channel partner for sale and/or distribution, or any other entity that receives goods from another for consumption, sale/resale, and/or distribution.

In one aspect of the present invention, the inventive integrated merchandise returns system (IMRS) automatically ascertains, in view of the items previously ordered by the customer, a return transaction definition, and the predefined business rules reflecting the current return policy of the merchant, whether a previously ordered item is eligible for return as requested by the customer. The return transaction definition generally includes the customer-supplied information about the reason for the return (e.g., buyer's remorse, damage during shipping, wrong color, dead on arrival, and the like) and information pertaining to the return transaction type. The return transaction type may be furnished by the customer in the form of a customer's desired transaction or may be automatically suggested by the system in the form of allowed return transaction type(s) in view of the furnished reason for the return and the business rules reflecting the current return policy of the merchant.

Furthermore, an item already subject to a return request may have its status updated and tracked by the IMRS in order to prevent fraud or error and to facilitate improved customer service. Preferably, the update is performed as soon as possible after an event capable of modifying that item's state occurs. For example, if the customer requests a return for credit for a particular ordered item of merchandise, that item of merchandise will have its state updated to reflect that it is currently in the process of being returned for credit. If the customer attempts to make another request for return for credit for that particular item, the updated state will cause the logic in the IMRS to prevent that item from being deemed eligible for the second return attempt. Further, as that item proceeds along the return process, e.g., when the item is received from the customer, when the customer's account is credited or debited, its state is updated. In one embodiment, certain conversations, discussions, or actions pertaining to the item to be returned are also noted. In this manner, the status of the item to be returned is readily ascertainable at any time to facilitate auditing and/or to respond to the customer's inquiry.

By automatically ascertaining whether a previously ordered item is eligible for return in view of the return transaction definition and the predefined business rules, the invention advantageously enforces, in an automatic and uniform manner across the customer base and/or the entire staff of customer service agents, the current return policy of the merchant. Furthermore, by timely and accurately recording any change in the return-related status of an ordered item and employing such status when responding to a customer's inquiry or to service a return request pertaining to the same ordered item, the IMRS can provide accurate and timely status information pertaining to a returned item while minimizing fraud and/or errors.

In one embodiment, the IMRS is integrated with the merchant's order management system. That is, the IMRS is preferably implemented as an integrated function of the software/hardware platform that the merchant employs to take, execute, and track orders from customers. Additionally or alternately, the IMRS preferably stores its return-related information in the order management system's database using substantially the same database technology as that employed by the order management system The tight integration allows the IMRS to seamlessly access a customer's previously ordered items and facilitates seamless exchanges in which the customer replaces a previously ordered item with another item Furthermore, the tight integration allows the customer's financial accounting to be integrated across the ordering and the merchandise returning transactions. The tight integration also reduces the amount of time and effort required to train customer service agents, who may already be familiar with the order management system, to efficiently work with the IMRS.

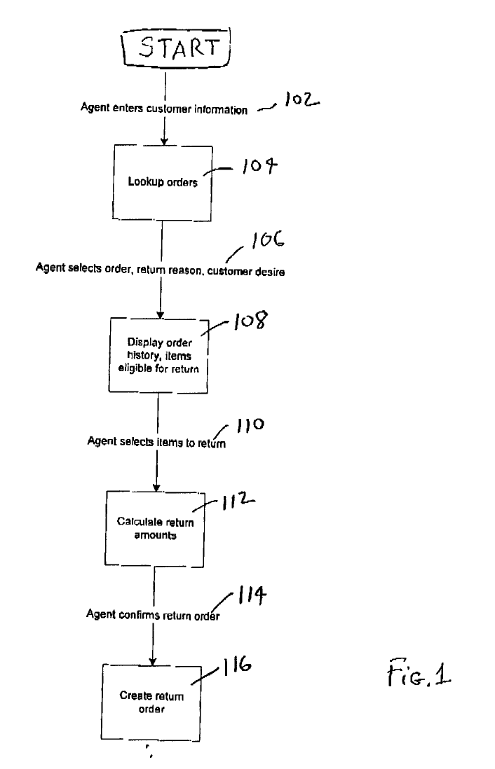

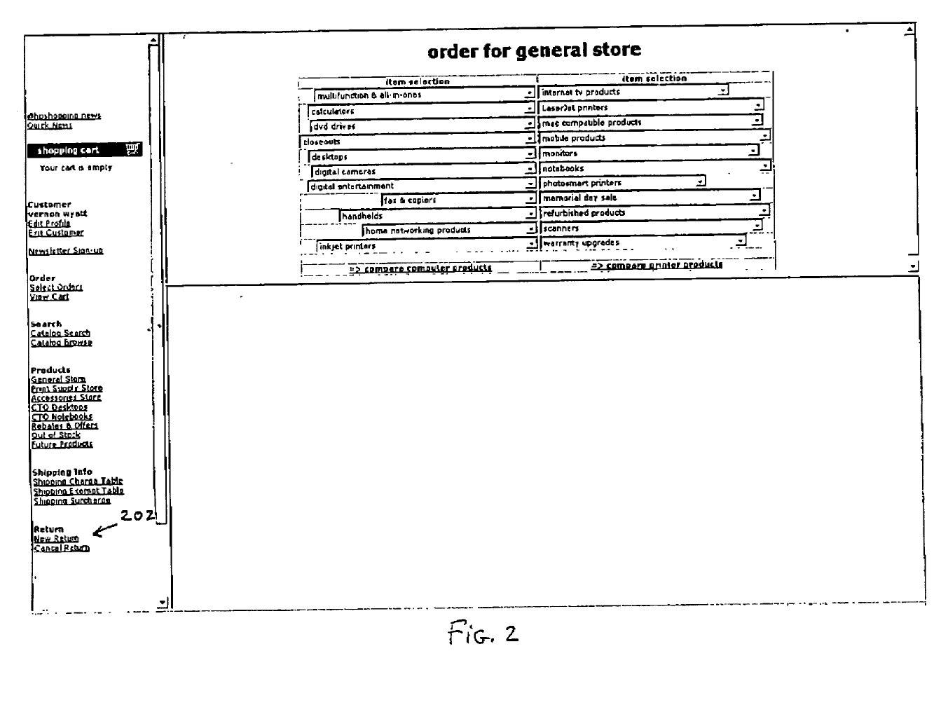

The features and advantages of the present invention may be better understood with reference to the drawings and discussions that follow. FIG. 1 shows, in accordance with one embodiment of the present invention, an exemplary flow chart describing the various steps associated with the front-end portion of a typical agent-assisted return for credit process. In step 102, the customer identification data is entered by the customer service agent. Generally speaking, the customer identification data may represent any customer-related information that can uniquely identify a customer among customers of the merchant. For example, the customer identification data may include one or more of the customer's account number, the customer's phone number, the customer's name, the confirmation number of an order previously made by a customer, and the like.

In the example of FIG. 1, the previously ordered items are then looked up using the order transaction number, such as the number associated with the original purchase or shipping order. Thus, in step 104, the customer identification data is employed to look up the customer's previous order transactions. In step 106, the customer indicates to the customer service agent which previous order transaction includes the item(s) to be returned. Also in step 106, the customer may indicate the return transaction definition, including the reason for the return and the type of return transaction desired by the customer. In step 108, the IMRS automatically ascertains and displays, for the selected order transaction, the previously ordered items that are eligible for return in view of the return transaction definition and the business rules reflecting the current return policy of the merchant. For example, a customer may indicate in step 106 that the item to be returned is associated with the original order transaction number 2344, and the customer wishes to return that item for credit. In step 108, the IMRS automatically ascertains and displays items in original order transaction number 2344 that are eligible for return for credit. Additionally, in step 108, the IMRS automatically ascertains and displays items from the original order transaction that have previously been returned.

In contrast to prior art approaches which may incorporate the merchant's return policy into the software as hard codes, the IMRS employs, in accordance with one embodiment of the present invention, predefined business rules in determining whether a particular item is return-eligible. These business rules are stored in the database and applied against an item by business logic software during the eligibility determination process. By employing business rules in determining whether an item is eligible for a particular type of return instead of hard coding these return policies into the software code, the IMRS advantageously allows the eligibility criteria to be flexibly modifiable without requiring extensive recoding. Thus when the merchant's return policy changes, little if any recoding is required.

Note that it is not always a requirement to categorize the previously ordered items according to their original order transactions. That is, the IMRS can also employ the customer identification data to obtain a list of all previously ordered items, which may be unsorted, sorted according to date, sorted according to cost, sorted according to item type, and the like. From this list of previously ordered items, the items eligible for return, which are determined in accordance with the return transaction definition and the merchant's business rules, may then be flagged and displayed to the user of the IMRS.

In step 110, the agent is instructed by the customer to select one of the return-eligible items for the return transaction. If the customer wishes to perform the desired return transaction with respect to a previously ordered item that has been deemed ineligible for such return transaction, the customer may be informed of such ineligibility. If the customer insists, it is possible for the merchant to grant, in some cases, an exception and to allow an item deemed ineligible for return by the logic of the IMRS to be returned. Some merchant may favor such an exception mechanism to handle their sensitive return issues, such as those involving extenuating circumstances or those involving a high profile or favored customer.

In step 112, any credit or debit amount that may be due is calculated. For example, the customer may be credited with a refund of the entire amount paid or a portion thereof (such as the difference between the original purchase price and the price of a lower-cost exchange item, a portion of the shipping cost, or the like) as a result of the return transaction. The customer may also be debited, for example, for any difference between the original purchase price and the price of a higher-cost exchange item. The credit or debit amount may be adjusted in view of other factors as dictated by the business rules.

In step 114, the agent confirms the return order with the customer. If confirmation is approved, the return order is created in step 116.

Note that it is not necessary that the customer service agent be involved in the process of returning an item in all cases. In other words, the IMRS may be made interactive such that the customer himself may enter any required information and make any required selection with the IMRS. By way of example, the user interface portion of the IMRS may be made accessible to the customer via the Internet through which the customer may enter any required data or make any required selection to complete a return order. Of course the selections allowable are filtered by the business rules and the IMRS logic to ensure that the return transactions performed by the customer conform with the return policy of the merchant.

FIGS. 2, 3, 4, 5, 6A, 6B, 7A, 7B, 8A, 8B, 8C, and 8D show various exemplary display screens that may be generated during the return invoice creation process. FIG. 2 shows, in accordance with one embodiment of the present invention, the menu page of an order management system having an integrated return management capability. This menu page, entitled “order for general store” in the exemplary implementation, may be shown after the customer is logged in The selections pertaining to merchandise returns are shown by reference number 202 in the example of FIG. 2.

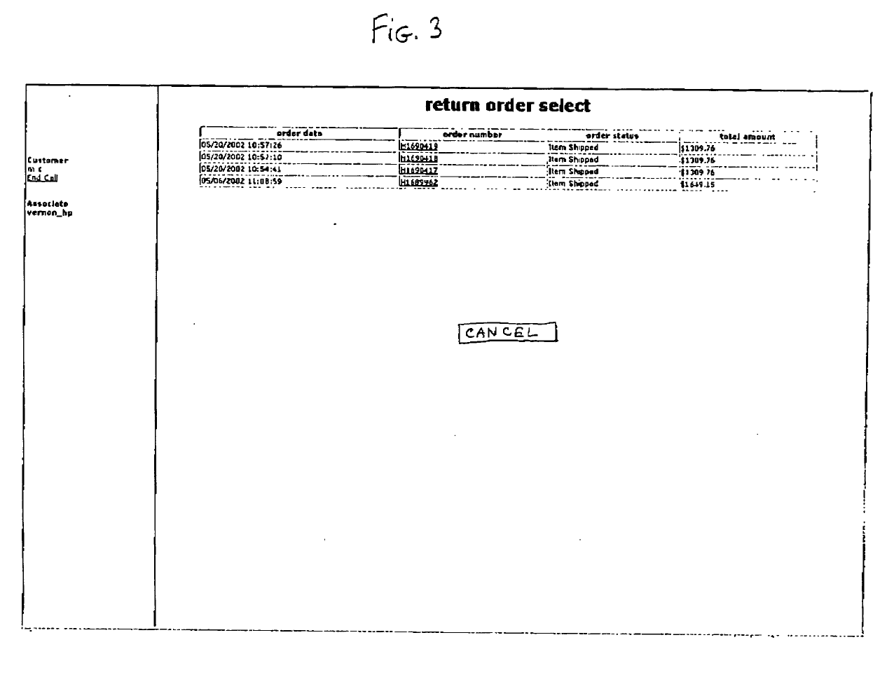

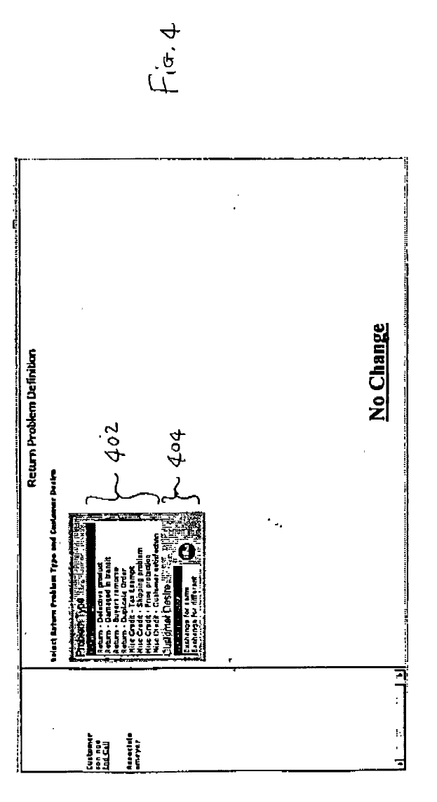

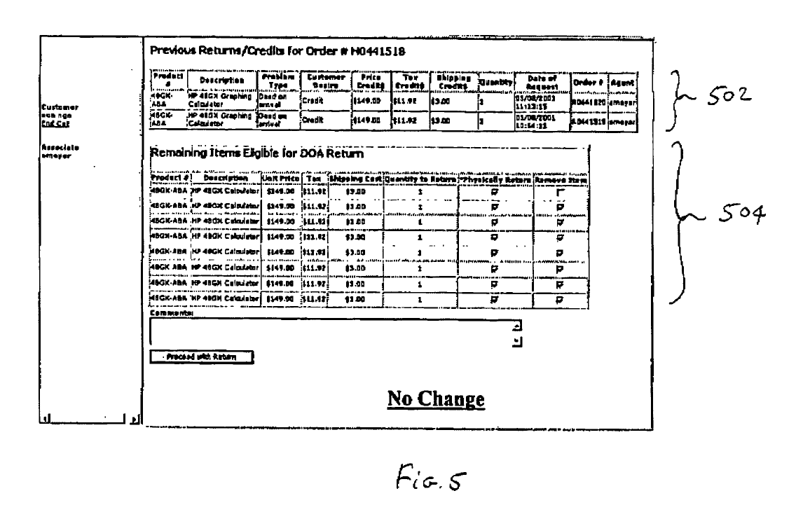

FIG. 3 illustrates, in accordance with one embodiment of the present invention, a screen for displaying the customer's past order transactions. The user of the IMRS (e.g., either the customer service agent or the customer himself) may then select one of the displayed past order transactions to proceed to the return transaction definition screen and to furnish the return transaction definition. Thus, in the exemplary screen of FIG. 4, the IMRS user may enter the problem type by selecting one of the predefined problem types in box 402. Also in FIG. 4, the user may enter the return transaction type (e.g., a return for credit, an exchange for an item of equal value, or an exchange for an item having a different value). The choices pertaining to the return transaction type are shown in box 404 in FIG. 4 (labeled “Customer Desire” in the example of FIG. 1).

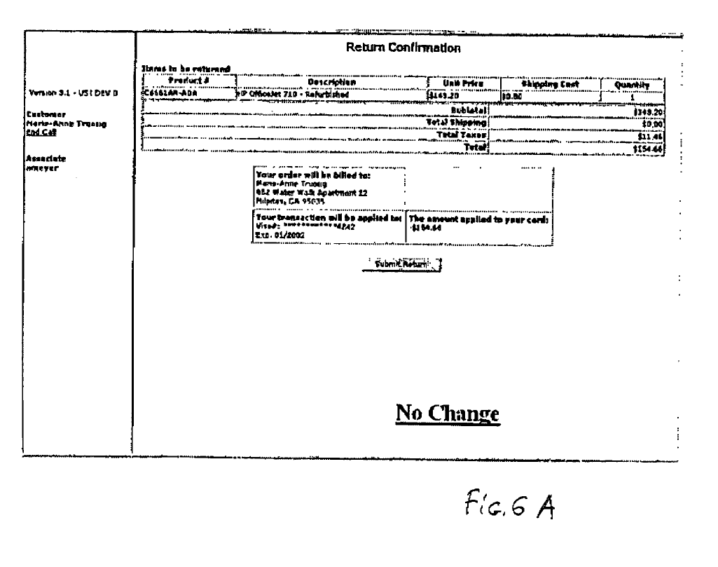

Once the return transaction definition is furnished, the IMRS user may proceed to the exemplary return item selection screen of FIG. 5. In FIG. 5, the items purchased pursuant to the original order transaction #H0441518 are divided into many different sets for ease of viewing. The IMRS user is shown both the items for which return requests have been initiated (shown in panel 502), as well as the items eligible for return in view of the return transaction definition (e.g., dead-on-arrival in this case) and the business rules stored in the IMRS database. These return-eligible items are shown in panel 504 of FIG. 5. Not shown in FIG. 5 but may be accessible by appropriate navigation steps are the items that are neither subject to return requests nor eligible for return in view of the return transaction definition and the business rules stored in the IMRS database.

By way of example, if the user wishes to return a purchased surplus memory component for credit, and the merchant's return policy on surplus component does not allow purchased surplus components to be returned for credit even due to dead-on-arrival, the purchased surplus memory component may not be shown in the return item selection screen of FIG. 5 but the information pertaining thereto may be accessible to the IMRS user in another screen, for example. By automatically filtering the purchased items according to the return transaction definition and the business rules stored in the IMRS database and presenting for selection only the return-eligible items, the IMRS system substantially improves user-friendliness and ease-of-use while minimizing the potential for fraud and/or errors.

In one embodiment, each return-eligible item can be handled in a separate return transaction. Accordingly, the “Quantity to Return” column in FIG. 5 shows the quantity of 1 for each return-eligible item. In this manner, even if the customer purchased multiple identical items in a single order transaction and wishes to return only one of those multiple identical items, the IMRS can accommodate this single, item-level return transaction without requiring the customer to return all items under that original order transaction.

Furthermore, the ability to handle return a at the item level and treating each item as a separate return transaction allows the customer, if desired, to more precisely specify the return transaction definition for each item of the original order transaction. The ability to more precisely define the return transaction definition improves the ability of the IMRS to filter out the items ineligible for returns and to allow the IMRS to follow more closely the merchant's return policy. As an example, if the customer was shipped three identical calculators and now wishes to return two of the calculators, say one for dead-on-arrival and one for buyer's remorse, these different reasons may be defined as such on two separate transactions. If the merchant's return policy does not allow a return for buyer's remorse, the fact that the returns are handled on different transactions enables the IMRS to deem one calculator return-eligible on the first return transaction and one calculator ineligible for return on the second return transaction.

On the other hand, it is permissible to handle multiple items in a single return transaction if the customer so desires. Also, the IMRS may present an explanation of the merchant's return policy for any item deemed ineligible for return, if such is desired.

FIG. 5 also shows a column entitled “Physical Return.” This column contains the physical return parameter that governs whether a particular item to be returned needs to be physically shipped back to the merchant. The determination of whether a particular item to be returned needs to be shipped back to the merchant may be governed by one or more business rules. By way of example, a business rule may specify that only items costing more than $50 need to be shipped back. However, the customer service agent may override, in one embodiment, the IMRS-recommended physical return value to account for other factors.

For example, if the customer service agent senses that the customer was trying to obtain another item for free, the customer service agent may override the IMRS-recommended physical return value for that item and specify that the item be shipped back irrespective of its original cost. As another example, if the customer is physically-challenged, the customer service agent may override the IMRS-recommended physical return recommendation and exempt the customer from having to ship back the item Of course, if such override feature is not desired by the merchant, the values in the “Physical Return” column may be made non-modifiable in which case the IMRS user has no discretion with regard to whether a returned item needs to be shipped back to the merchant.

FIG. 5 also shows a column entitled “Remove Item” This is an IMRS user-settable flag to indicate whether the customer wishes to return an item in FIG. 5. In the example of FIG. 5, the system interprets the absence of a check mark as the desire to proceed with returning an item. Conversely, the presence of a check mark flags the desire to remove the item from return consideration (i.e., the customer does not want to return the item).

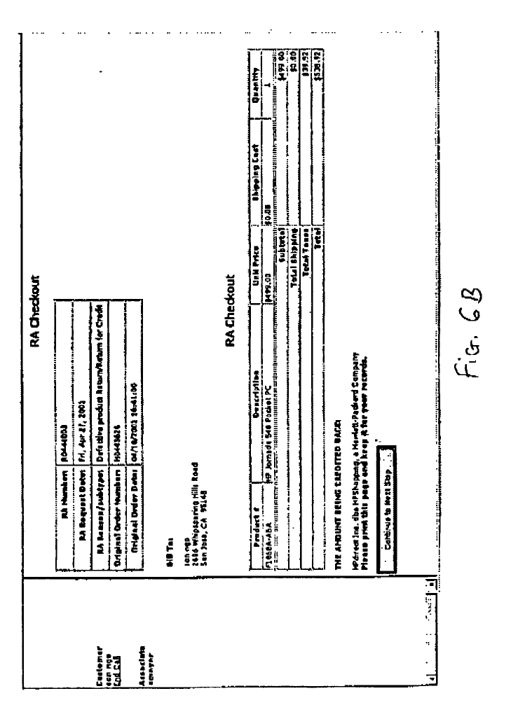

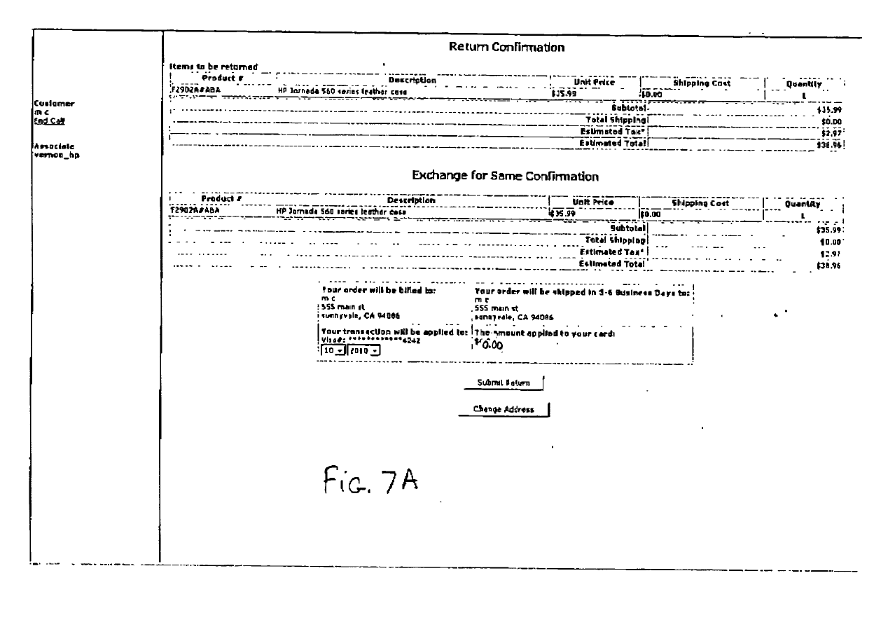

In exemplary FIGS. 6A and 6B, the follow-up screens for handling a return for credit transaction are shown. Once the IMRS user selects one of the return-eligible items displayed in FIG. 5, the “Return Confirmation” screen of FIG. 6A is displayed to allow the IMRS user to review the return transaction and to confirm if all is correct or to go back (via the “Back” button of the browser, for example) if the IMRS user wishes to edit the return transaction. Note that the IMRS already knew of the user's desire to return the item for credit from the return transaction definition step. If the IMRS user confirms, the check out invoice is shown in FIG. 6B.

In exemplary FIGS. 7A and 7B, the follow-up screens for handling a return transaction in which there is an exchange for an item of equal value are shown. Once the IMRS user selects one of the return-eligible items displayed in FIG. 5, the “Return Confirmation” screen of FIG. 7A is displayed to allow the IMRS user to review the return transaction and to confirm if all is correct or to go back (via the “Back” button of the browser, for example) if the IMRS user wishes to edit the return transaction. Note that the IMRS already knew of the user's desire to exchange for an identical item from the return transaction definition step. If the IMRS user confirms, the check out invoice is shown in FIG. 7B.

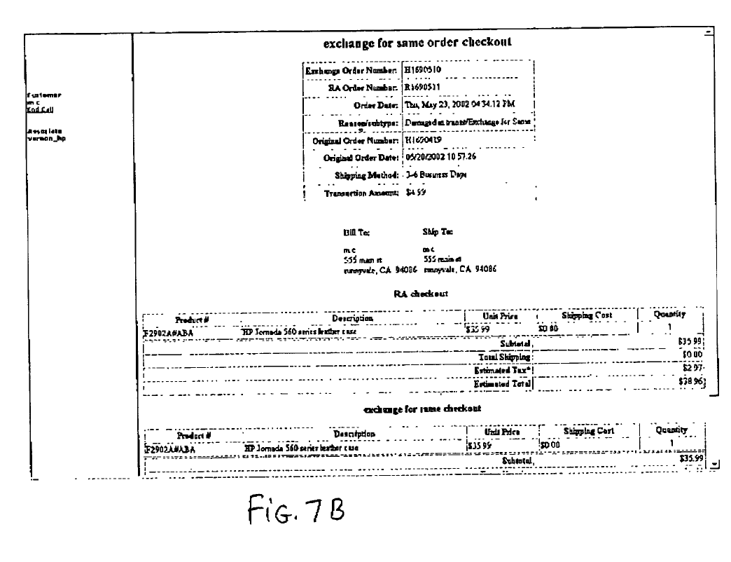

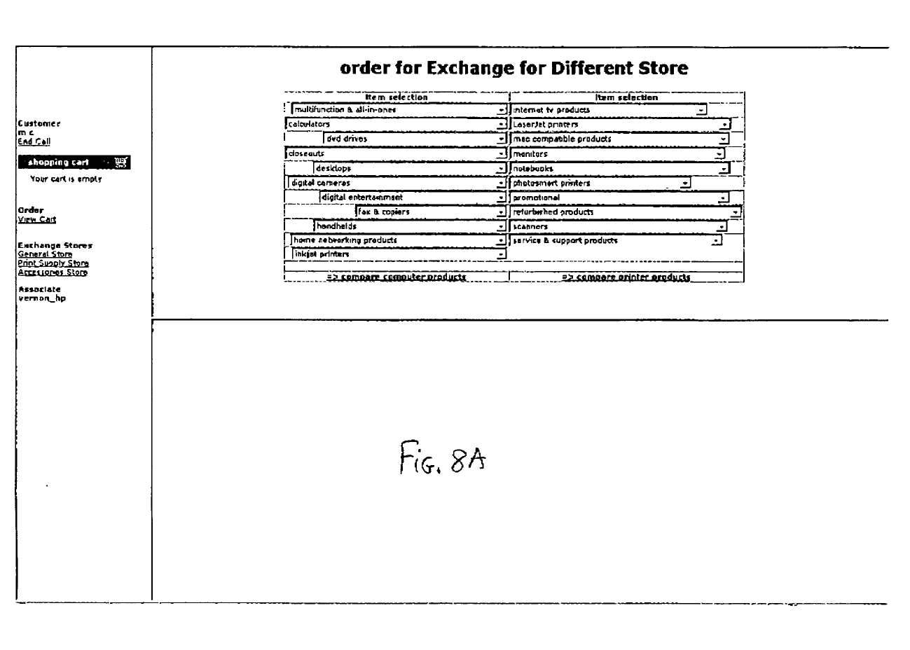

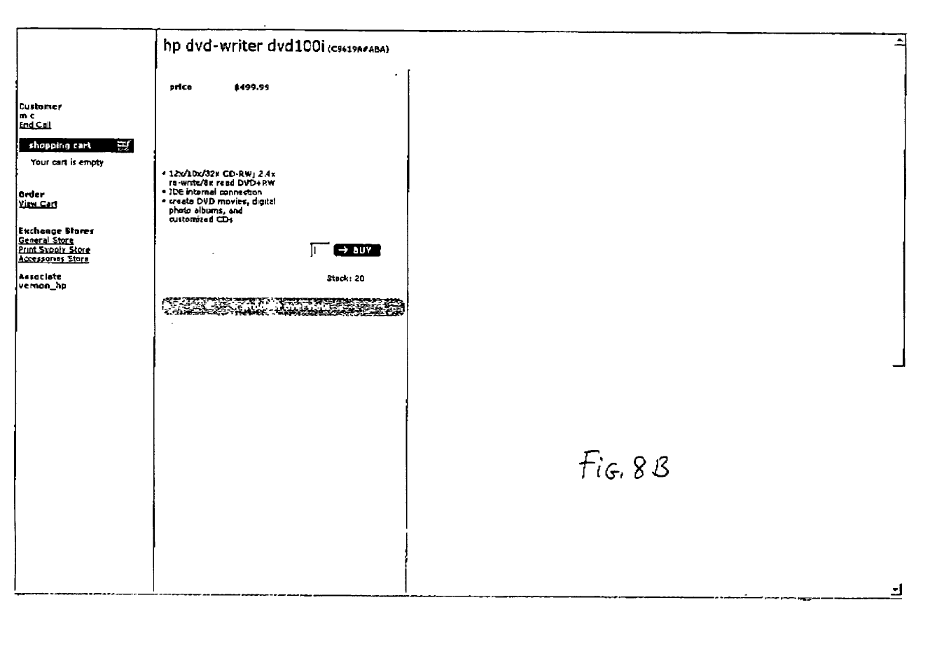

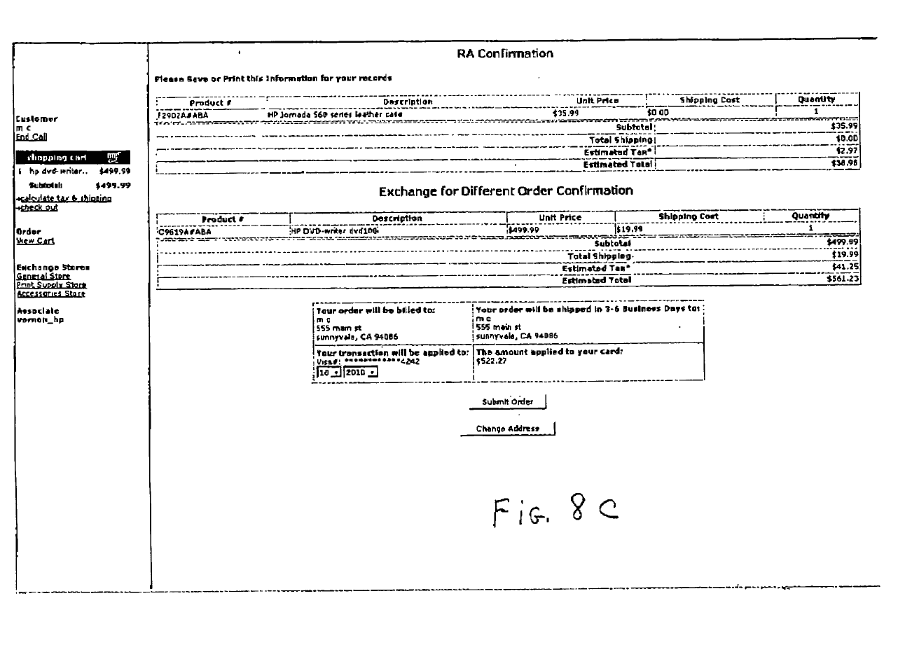

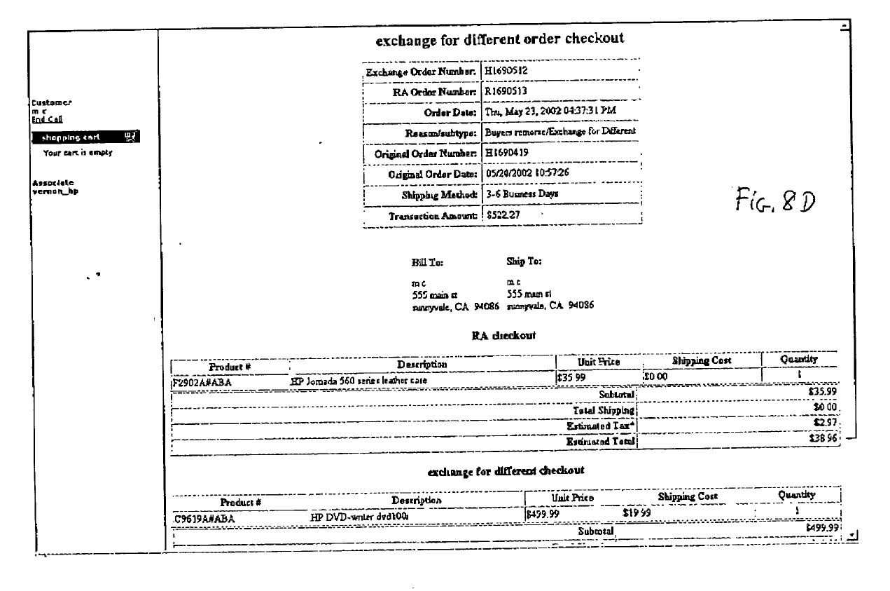

In exemplary FIGS. 8A-8D, the follow-up screens for handling a return transaction in which there is an exchange for an item having a different value are shown. Once the IMRS user selects one of the return-eligible items displayed in FIG. 5, the “order for Exchange for Different Store” screen of FIG. 8A is displayed to allow the IMRS user to select the item to be exchanged. Note that the IMRS already knew of the user's desire to exchange for an item having a different value from the return transaction definition step. The IMRS user can select the desired exchange item, which happens to be the HP DVD writer dvd100i shown in FIG. 8B. The confirmation and check out screens for this transaction are shown in FIG. 8C and FIG. 8D respectively.

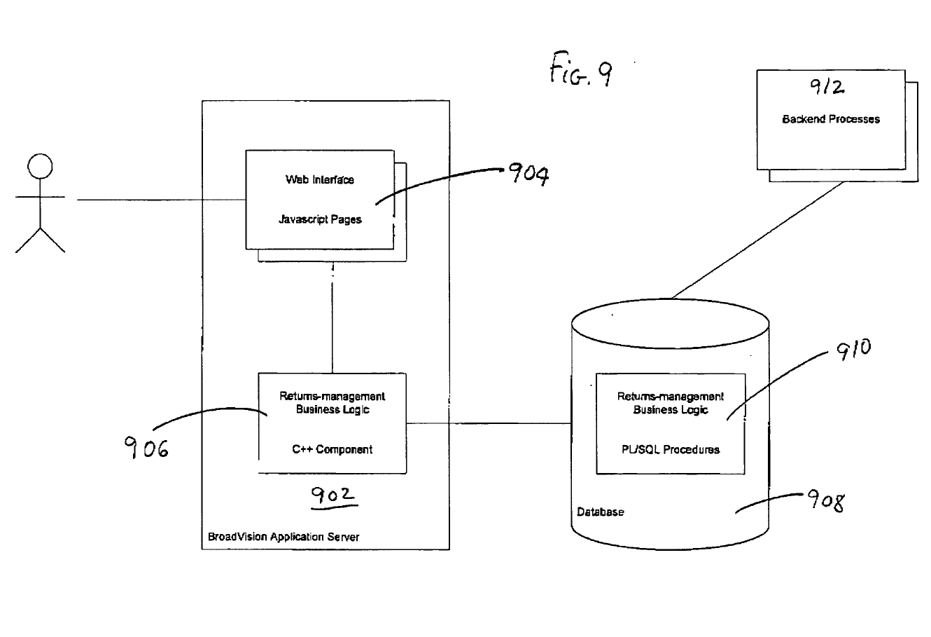

FIG. 9 illustrates, in accordance with one embodiment of the present invention, a diagram showing the various components of the integrated merchandise return system (IMRS). The IMRS is preferably integrated with the merchant's order management system. In the example of FIG. 9, the IMRS is integrated with and is an additional feature to the Broadvision One-to-One Enterprise Application (version 4.1) available from Broadvision Corporation of Redwood City, Calif. Thus, there is integrated with the application server 902 a user interface module 904, which is implemented as a web interface by Javascript pages in the example of FIG. 9. Of course Javascript and the web are only exemplary technologies, and the user interface module may be implemented by any other suitable user-interface programming techniques and/or technologies. The user interface module 904 is employed to interact with the IMRS user to obtain, for example, the customer identification data and the return transaction definition.

There is also shown an application-side business logic module 906, which is implemented by the C++ language. Business logic module 906 is coupled to exchange data with user interface module 904 and a database 908. Again, C++ is not a requirement and business logic module 906 may be implemented using any suitable programming techniques and/or technologies. Business logic module 906 represents the component that contains the executable code to handle, for example, applying business rules against a proposed return transaction and/or performing financial calculations to inform the customer of the charges to be applied pursuant to a given proposed return transaction. The business rules themselves, as well as the merchandise-related data, are stored in database 908, which is implemented by a relational database in the example of FIG. 9.

In the Broadvision implementation, user interface module 904 and business logic module 906 employ the APIs (Application Programming Interfaces) supplied with the Broadvision application package (e.g., Broadvision One-to-One Enterprise Application version 4.1 and Broadvision One-to-One Commerce Web Application version 4.1) to integrate the returns management functionality with the order management functions supplied with the Broadvision application package. The business rules and return-related data are stored as additional tables in the relational database associated with the Broadvision application package.

FIG. 9 also shows a database-side business logic module 910, representing the database-related commands and functions for manipulating, reading, and storing data in the various database tables in response to activities taken vis-a-vis user interface module 904 and/or application-side business logic module 906. In the example of FIG. 9, the database-side business logic module 910 is implemented via PL/SQL technology although any other suitable database technology may also be employed.

A backend processing module 912 is also shown, representing the logic component for handling backend processes that are required to complete the return transaction. These processes are called backend processes since they occur in the background after the return order is received from the customer. Exemplary backend processes include coordinating and tracking shipment of the exchange item as well as any required returned item, financially settling with the customer's account to credit or debit any charge as necessitated by the return transaction, and the like.

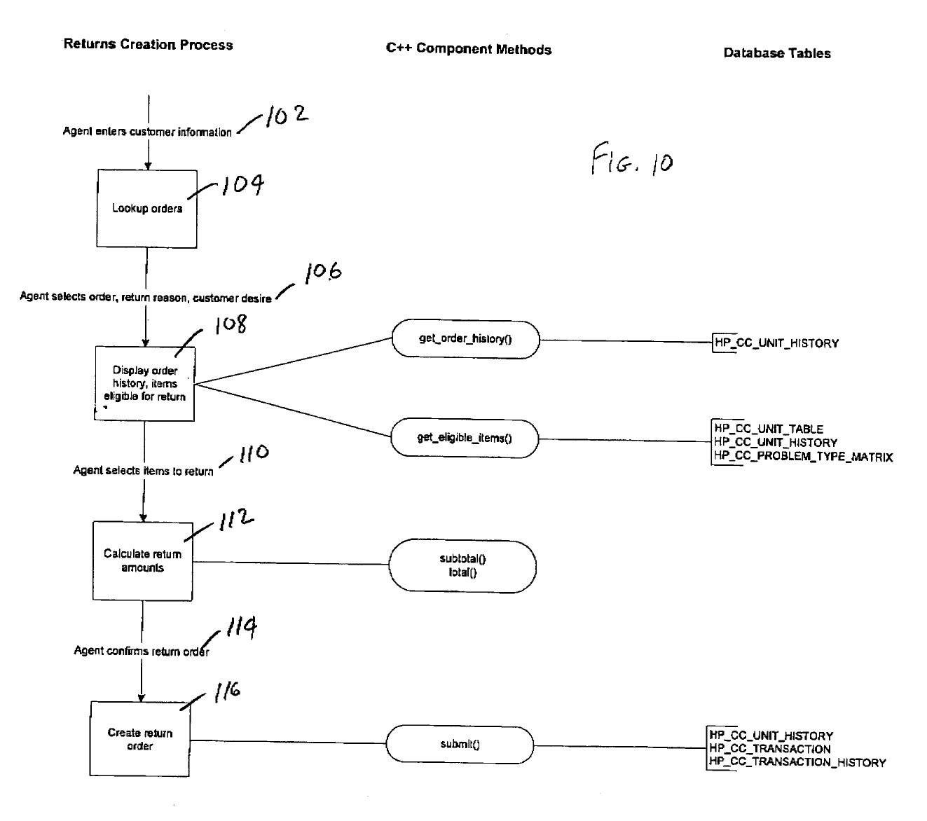

As mentioned, the return-related data is preferably stored as tables in the relational database. FIG. 10 shows, in accordance with one embodiment of the present invention, the exemplary business logic functions as well as database tables involved in the agent-assisted return transaction of FIG. 1. Steps 102, 104, 106, 108, 110, 112, 114, and 116 have been discussed earlier in connection with FIG. 1 and will not be repeated here. With reference to step 108, for example, the business logic function get_order_history ( ) is called upon to obtain the order history of the specified order transaction, including any return transaction subsequently requested for the items in the specified order transaction. An exemplary order history is shown in FIG. 5 in panel 502. The table in which such order history is stored is shown to be HP_CC_UNIT_HISTORY in FIG. 10.

Step 108 also calls on the business logic function get_eligible_items ( ) to obtain the return-eligible items from specified order transaction, taking into account the return transaction definition and the predefined business rules. An exemplary list of return-eligible items is shown in FIG. 5 in panel 504. In FIG. 10, the tables employed for the eligibility determination process are shown to include HP_CC_UNIT_TABLE, HP_CC_UNIT_HISTORY, and HP_CC_PROBLEM_TYPE_MATRIX. HP_CC_UNIT_TABLE represents the table storing all items of merchandise associated with the original order transaction. HP_CC_PROBLEM_TYPE_MATRIX represents the table storing the return-related business rules that reflect the returns policy of the merchant. HP_CC_UNIT_HISTORY table is consulted again to ensure that an item already subject to a return transaction is not deemed eligible again for a duplicate and/or conflicting request for return.

Step 112 employs the business logic functions subtotal ( ) and total ( ) to obtain the amount to be refunded to the customer in the exemplary return-for-credit scenario of FIG. 1. Step 116 employs the logic function submit ( ) to update return-related data to the various tables once the customer approves the return transaction. In FIG. 10, these tables include HP_CC_UNIT_HISTORY, HP_CC_TRANSACTION, and HP_CC_TRANSACTION_HISTORY. HP_CC_UNIT_HISTORY is updated to reflect the fact that additional items in the original order transaction are subject to return requests. HP_CC_TRANSACTION represents the table that contains the order-level information about a return transaction, such as the original order transaction number, the total amount to be credited or debited, the transaction state, the return reason, and the like. HP_CC_UNIT_HISTORY represents the table that contains the item-level information about a return transaction, such as per-item amounts to be debited. By looking at the HP_CC_UNIT_HISTORY table, the system can determine which items from the original order have already been returned).

In one embodiment, each item to be returned is associated with a return-related state parameter. The value of the state parameter reflects the current status for the associated returned item and is updated any time an event capable of modifying such state occurs. For example, one state value may be “awaiting return shipment,” representing the fact that the merchant is waiting for the receipt of the returned item from the customer. This state value may be changed by the warehouse process of the merchant once the returned item is received at the merchant's shipping dock. Another state value may be “exchange item back-ordered,” representing the fact that the exchange item is not yet available for shipment to the customer. This state value may be updated by the warehouse process of the merchant as well. Another state value may be “credit card declined,” representing the fact that the customer's credit card has been declined and the merchant was unable to charge the customer for the amount due. This state value may be updated by the financial process of the merchant. Other state values exist to reflect the different status of a return transaction.

HP_CC_TRANSACTION_HISTORY represents the table for storing all state changes associated with a returned item Each time the state changes, that change as well as the new state value is noted in the table HP_CC_TRANSACTION_HISTORY, including preferably the time and date the change occurs and/or the agent/division/process responsible for entering the change. The table HP_CC_TRANSACTION_HISTORY represents an audit trail to enable the merchant to audit the return process. The table HP_CC_TRANSACTION_HISTORY may also be consulted to quickly determine the current status of a return order if such information is requested by the customer or merchant. By tracking the various return-related state values in a table and tracking the changes therefor, the invention advantageously provides an auditing tool as well as a way to obtain an instantaneous current snapshop of the status of a return order and any history leading up to the current status.

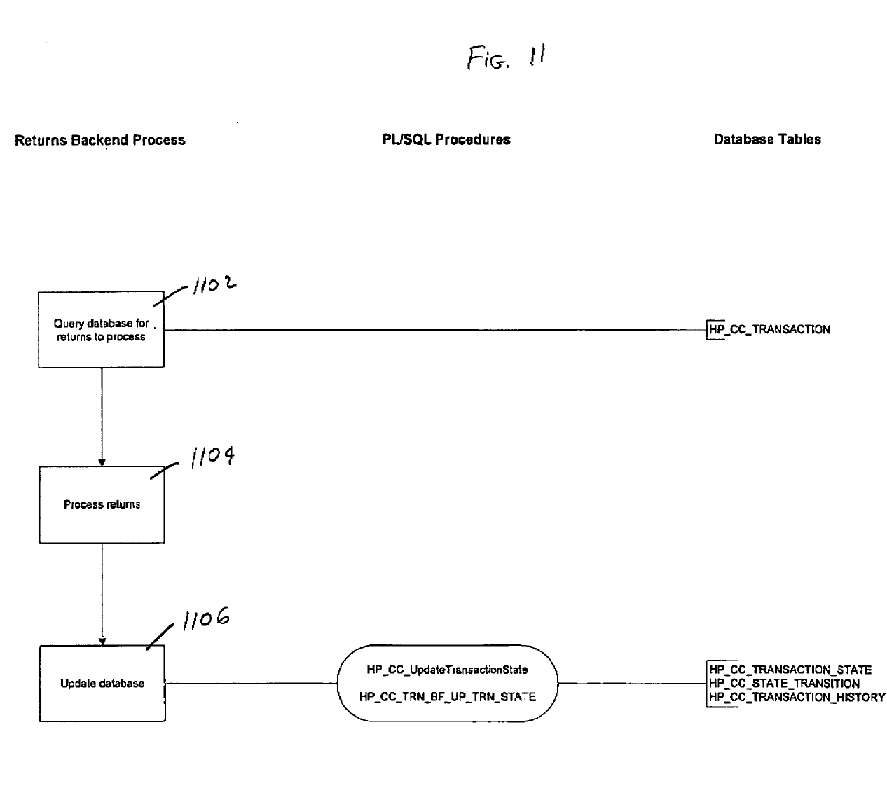

FIG. 11 shows, in one embodiment, an exemplary flow for backend processing. As mentioned earlier, backend processing may occur as part of the return process. For example, one backend process may handle crediting the customer's credit card with the refund amount once the returned item is received at the merchant's shipping dock. Thus, in step 1102, this backend process may query the database for return orders that are ready for crediting. If the warehouse process updates the state of one of the return orders to reflect that the returned item therefor is already received and that return order is now deemed ready for crediting, the backend process for crediting will pick up that return order in step 1102. The tables employed during this determination process include HP_CC_TRANSACTION, which is consulted to determine which return orders are ready for backend processing.

In step 1104, the backend process is executed. In this example, the customer's credit card is credited with the appropriate amount in this step 1104. In step 1106, the database is updated to reflect the completion of the specific backend process. The tables involved in this step 1106 include HP_CC_TRANSACTION_STATE, HP_CC_STATE_TRANSITION, and HP_CC_TRANSACTION_HISTORY. HP_CC_TRANSACTION_STATE is the master table where all possible states are stored. HP_CC_TRANSACTION_STATE is consulted to determine the appropriate state value to update to the other tables. HP_CC_STATE_TRANSITION is the table storing the state flow, which determines the sequence of state transitions expected. HP_CC_STATE_TRANSITION is consulted to determine what the next state value should be for the return order at issue. As mentioned, HP_CC_TRANSACTION_HISTORY represents the master table for storing all state changes associated with a returned item Thus, if the current backend process affects the state of a returned item (and thus the return order associated therewith), the change is updated in HP_CC_TRANSACTION_HISTORY for auditing and/or tracking purposes.

Thus, while this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for handling a merchandise return request from a customer of a merchant, comprising:
receiving customer identification data, said customer identification data being capable of uniquely identifying said customer among customers of said merchant;
receiving a return transaction definition, said return transaction definition includes at least one of a problem type parameter and a return transaction type parameter; and
automatically ascertaining, from a database of items previously ordered, a set of return-eligible items, each return-eligible item in said set of return-eligible items representing an item of merchandise previously ordered by said customer that conforms to said return transaction definition and predefined return-related business rules of said merchant.

2. The computer-implemented method of claim 1 further comprising receiving an order transaction number, said order transaction number identifying a previous order for merchandise by said customer, wherein said set of return-eligible items includes only return-eligible items from said previous order.

3. The computer-implemented method of claim 1 wherein said predefined return-related business rules includes current rules pertaining to a merchandise return policy of said merchant.

4. The computer-implemented method of claim 3 wherein said predefined return-related business rules are stored in a table in a relational database.

5. The computer-implemented method of claim 1 wherein an item of merchandise associated with a request for return by said customer has an associated state parameter reflecting a state of said item of merchandise in a return process, said state parameter having one of a plurality of predefined state values, said state parameter being updated to reflect said state of said item of merchandise in said return process after an event capable of modifying said state occurs.

6. The computer-implemented method of claim 5 further including creating a return transaction history with respect to said item associated with said request for return, said return transaction history representing a log of events that have taken place with respect to said item associated with said request for return, at lease two events in said log of events pertain to two different states of said item of merchandise in said return process.

7. The computer-implemented method of claim 1 wherein said return transaction type parameter includes one of a return for credit, an exchange for an item of equal value, and an exchange for an item having a different value.

8. The computer-implemented method of claim 1 wherein said database of items previously ordered is maintained by an order management system.

9. The computer-implemented method of claim 8 wherein said predefined return-related business rules are stored in a table in a relational database associated with said order management system.

10. The computer-implemented method of claim 1 wherein said predefined return-related business rules includes a rule prohibiting an item of merchandise already subject to a request for return for credit from being deemed eligible for another request for return for credit.

11. The computer-implemented method of claim 1 further comprising backend processing for executing a set of backend processes associated with said merchandise return request from said customer, said set of backend processes includes one of tracking a receipt by said merchant of returned merchandise shipped from said customer and settling financially with said customer pursuant to said merchandise return request.

12. The computer-implemented method of claim 11 wherein said predefined return-related business rules include a rule for settling financially with said customer pursuant to said merchandise return request only after returned merchandise is received from said customer.

13. A computer-implemented returns management system for handling merchandise return requests from customers of a merchant, comprising:
a plurality of tables implemented in a relational database;
a user-interface module configured to interact with one of a customer of said merchant and a customer service agent of said merchant, said user-interface module being configured to receive customer identification data and a return transaction definition associated with a request for merchandise return from a customer associated with said customer identification data; and
a business logic module communicably coupled with said user interface module and said plurality of tables, said business logic module including computer instructions for ascertaining whether an item of merchandise previously purchased by said customer is eligible for return based on said return transaction definition and predefined return-related business rules of said merchant.

14. The computer-implemented returns management system of claim 13 wherein said predefined return-related business rules are stored in a first table of said plurality of tables.

15. The computer-implemented returns management system of claim 14 wherein a rule in said predefined return-related business rules prohibits an item of merchandise already subject to a request for return for credit from being deemed eligible for another request for return for credit.

16. The computer-implemented returns management system of claim 15 wherein a second table of said plurality of tables stores a value for a state parameter that is associated with an item of merchandise subject to a request for return by said customer, said value for said state parameter reflecting a state of said item of merchandise in a return process, said state parameter being updated to reflect said state of said item of merchandise in said return process after an event capable of modifying said state occurs.

17. The computer-implemented returns management system of claim 16 wherein a third table of said plurality of tables stores a return transaction history with respect to said item subject to said request for return, said return transaction history representing a log of events that have taken place with respect to said item subject to said request for return, at lease two events in said log of events pertain to two different states of said item of merchandise in said return process, at least a portion of said log of events being viewable by a user of said computer-implemented returns management system upon request.

18. The computer-implemented method of claim 16 wherein said plurality of tables and said business logic module are implemented as extensions of an existing order management system.

19. The computer-implemented returns management system of claim 13 further comprising a backend processing module configured to execute a set of backend processes associated with said request for merchandise return from said customer, said set of backend processes includes one of tracking a receipt by said merchant of returned merchandise shipped from said customer and settling financially with said customer pursuant to said request for merchandise return.

20. A computer-implemented returns management system for handling merchandise return requests from customers of a merchant, comprising:
means for storing items previously ordered by customers of said merchant and predefined return-related business rules of said merchant;
means for receiving customer identification data and a return transaction definition associated with a request for merchandise return from a customer associated with said customer identification data; and
means for ascertaining, based on said return transaction definition and said predefined return-related business rules of said merchant, whether an item of merchandise previously purchased by said customer is eligible for return, said means for ascertaining being communicably coupled with said means for storing and means for receiving.

21. The computer-implemented returns management system of claim 20 wherein said means for receiving said customer identification data and said return transaction definition is an extension of an existing order management system.

22. The computer-implemented returns management system of claim 21 wherein an item of merchandise associated with a request for return by said customer has an associated state parameter reflecting a state of said item of merchandise in a return process, said state parameter having one of a plurality of predefined state values, said state parameter being updated to reflect said state of said item of merchandise in said return process after an event capable of modifying said state occurs.

23. The computer-implemented returns management system of claim 22 further including means for storing a return transaction history with respect to a given item subject to a return request, said return transaction history representing a log of events that have taken place with respect to said given item, at lease two events in said log of events pertain to two different states of said given item in said return process.

24. The computer-implemented method of claim 20 wherein said predefined return-related business rules includes a rule prohibiting an item of merchandise already subject to a request for return for credit from being deemed eligible for another request for return for credit.
